(19) United States
(12) Patent Application Publication
(10) Pub. No.: US 2004/0017078 A1
(43) Pub. Date: Jan. 29, 2004

(54) Connectors for microfluidic devices

(76) Inventors: Christoph D. Karp, Pasadena, CA (US); Eugene Dantsker, Sierra Madre, CA (US)

Correspondence Address: NANOSTREAM, INC., 580 SIERRA MADRE VILLA AVE., PASADENA, CA, 91107-2928, US

(21) Appl. No.: 10/405,078

(22) Filed: Mar. 31, 2003

Related U.S. Application Data
(60) Provisional application No. 60/370,107, filed on Apr. 2, 2002.

(51) Int. Cl. F16L 3/04

(52) U.S. Cl. 285/136.1

(57) ABSTRACT

A connector for a stencil-based microfluidic device is provided. A planar substrate is affixed to the stencil-based microfluidic structure. A nipple is formed in the substrate. The tip of the nipple is flush with or recessed from the surface of the substrate to avoid interference with fabrication tools and processes.

### STATEMENT OF RELATED APPLICATIONS

This application claims benefit of U.S. Provisional Patent Application Serial No. 60/370,107 filed Apr. 2, 2002 and currently pending.

### FIELD OF THE INVENTION

The present invention relates to connectors for interfacing fluidic conduits to microfluidic devices.

### BACKGROUND OF THE INVENTION

There has been a growing interest in the application of microfluidic systems to a variety of technical areas, including such diverse fields as biochemical analysis, medical diagnostics, chemical synthesis, and environmental monitoring. For example, use of microfluidic systems for acquiring chemical and biological information presents certain advantages. In particular, microfluidic systems permit complicated processes to be carried out using very small volumes of fluid. In addition to minimizing sample volume, microfluidic systems increase the response time of reactions and reduce reagent consumption. Furthermore, when conducted in microfluidic volumes, a large number of complicated biochemical reactions and/or processes may be carried out in a small area, such as in a single integrated device. Examples of desirable applications for microfluidic technology include analytical chemistry; chemical and biological synthesis, DNA amplification; and screening of chemical and biological agents for activity, among others.

Techniques conventionally employed to produce microfluidic devices include conventional surface micromachining and material deposition techniques, such as those used in the semiconductor manufacturing industry. In one technique, fluidic devices may be constructed using stencil layers or sheets to define channels and/or other microstructures. For example, a computer-controlled plotter modified to accept a cutting blade may be used to cut various patterns through a material layer. Such a blade may be used either to cut sections to be detached and removed from the stencil layer or to fashion slits that separate certain regions of a layer without removing any material. Other methods that may be employed to form stencil layers include conventional stamping or die-cutting technologies or laser cutting. The above-mentioned methods for cutting through a stencil layer or sheet permit robust devices to be fabricated quickly and inexpensively.

After a portion of a stencil layer is cut or removed, the outlines of the cut or otherwise removed portions form the lateral boundaries of microstructures that are completed upon sandwiching a stencil between substrates and/or other stencils. The thickness or height of the microstructures such as channels or chambers can be varied by altering the thickness of the stencil layer, or by using multiple substantially identical stencil layers stacked on top of one another. When assembled in a microfluidic device, the top and bottom surfaces of stencil layers are intended to mate with one or more adjacent layers (such as stencil layers or substrate layers) to form a substantially enclosed device, typically having at least one inlet port and at least one outlet port.

It would be desirable to produce relatively compact microfluidic systems to promote easy interface with standard laboratory instruments, including detection instruments such as plate readers, and dispensing equipment, including automated pipettors. However, current standard laboratory instruments and detectors are not designed to interface with microfluidic devices. Moreover, instrument interfaces may differ substantially, both in size and positioning, from instrument to instrument. Thus, microfluidic devices that may be used in more than one type or brand of instrument should have interfaces that are readily adapted to the variety of instrument in which they may be used. Also, the reagents used in such microfluidic devices often are expensive, require special disposal, and may even be hazardous. Consequently, an instrument-to-microfluidic-device interface should minimize the possibility of leakage or spills in order to limit the potential costs and health issues associated with such a spill. Finally, manufacturing techniques for microfluidic devices typically require the application of even pressures across the microfluidic device being manufactured. Accordingly, the external surfaces of the microfluidic devices should be free of any significant protrusions or depressions that would cause variations in pressure distribution within the device or interfere with manufacturing of, further processing of, or handling of the devices.

In the past, connectors for microfluidic devices have employed friction fittings for engaging flexible tubing, as illustrated in FIG. 1A. FIG. 1A illustrates a microfluidic device 10A with a recess 20A defined in the upper surface of a substrate 12A. The recess 20A is in fluid communication with a bore 18A, which in turn is in fluid communication with microfluidic structure 16A. A fluid conduit 14A is inserted into the recess 20A and is retained in position by friction. While this approach provides desired flexibility with regard to interface positioning and permitting connection with various laboratory instruments, the seal provided by this approach often is insufficient to prevent inadvertent disconnections, particularly when high pressures are applied to the system.

As illustrated in FIG. 1B, another approach has been to press a rigid fluid conduit 24 against a substrate 12B so that the fluid channel 26 of the arm 24 is in fluid communication with the bore 18B. A fluid-tight seal is provided at the interface by an O-ring 28. This approach provides the benefit of very rapid connection of the device 10B to the instrument in use. However, it may be necessary to apply substantial downward force on the arm 24 in order to provide a sufficiently tight seal in high-pressure applications. This downward force can distort or damage the microfluidic device 10B. Moreover, the rigid nature of the arm 24 may limit the compatibility of the device 10B among differing laboratory instruments.

Another conventional approach, illustrated in FIG. 1C, employs a nipple 30 protruding from the surface of the substrate 12C. A fluid conduit 14C is mounted on the nipple 30 and a frictional seal is created because the internal diameter of the conduit 14C is smaller than the outside diameter of the nipple 30. This approach provides a more positive seal than the above-described approaches and has proven suitable for high-pressure applications. Moreover, because it allows the use of flexible tubing, compatibility across different instruments is preserved. However, the protrusion of the nipple 30 from the surface of the substrate 12C significantly complicates the manufacture of the device 10C. If the nipple 30 is integral to the substrate 12C, it will necessarily be present when the substrate 12C is affixed to the microfluidic structure 16C. There are many approaches to joining these components—for instance, the various layers of the device 10C may be fed in sheets from rolls, which are registered and pressed together between rollers. Alternatively, the layers may be registered and sandwiched between platens that hold the layers in place while the selected bonding process is engaged (e.g., adhesives, thermal bonding, etc.). In either of these cases, the protrusion of the nipple 30 would interfere with or complicate the assembly process. The nipples 30 would prevent the use of rollers entirely as the nipples would prevent the substrate sheet from passing through the rollers. If platens were used, the platens would require holes to allow protrusion of the nipples 30. These holes may create inconsistencies in the pressure applied across the device, resulting in uneven or incomplete bonding. Moreover, different platens would be required for each new device design, or designs would be constrained to a fixed number of inlets and outlets in specific locations. One alternative is to attach the nipples 30 to the substrate 12C after the device 10C has been assembled; however, this approach also would complicate manufacture by introducing additional assembly requirements. Furthermore, the joint between the nipple 30 and the substrate 12C would be more susceptible to failure, particularly in high-pressure applications.

In light of the foregoing, there exists a need for microfluidic device connectors that allow connections between the device and various instruments without the need for modifications to customize the device for each differing instrument. There also exists a need for connectors that are compact, easy to fabricate, do not interfere with the manufacture of the device, and provide a tight, secure sealing utility, particularly in high-pressure applications.

### BRIEF DESCRIPTION OF THE DRAWINGS

FIGS. 1A-1C are cross-sectional views of prior art connectors for microfluidic devices.

FIG. 2A is a side cross-sectional view of a connector for microfluidic devices according to a first embodiment of the present invention.

FIG. 2B is a top cross-sectional view of a portion of the connector of FIG. 2A taken along Line “A”-“A”.

FIG. 3A is a side cross-sectional view of a connector for microfluidic devices according to a second embodiment of the present invention.

FIG. 3B is a side cross-sectional view of a connector for microfluidic devices according to a third embodiment of the present invention.

FIG. 3C is a side cross-sectional view of a connector for microfluidic devices according to a fourth embodiment of the present invention.

FIG. 3D is a side cross-sectional view of a connector for microfluidic devices according to a fifth embodiment of the present invention.

FIG. 4A is a cross-sectional view of a first drill bit useful for creating the connector of FIGS. 2A-2B.

FIG. 4B is a cross-sectional view of a second drill bit useful for creating the connector of FIG. 3D.

FIG. 4C is a cross-sectional view of a drill bit for useful creating the connector of FIG. 3B.

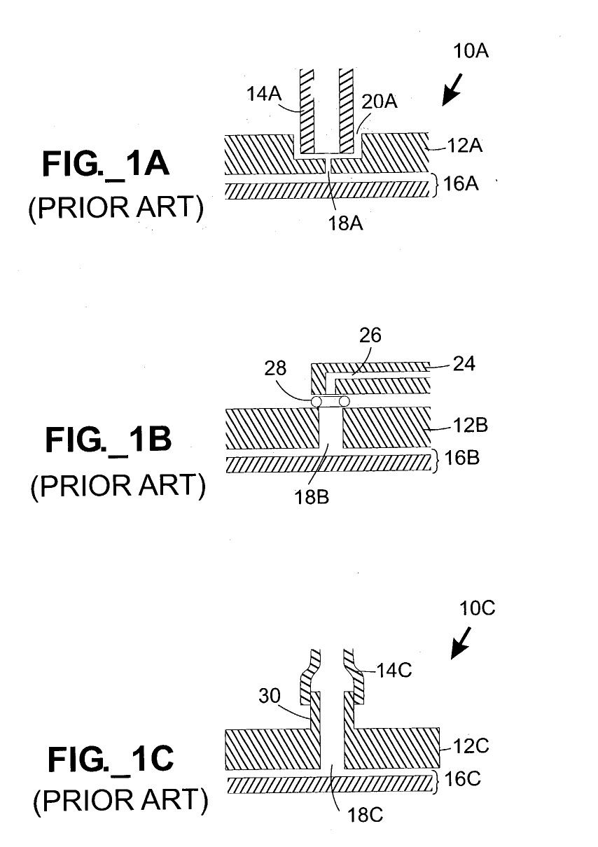

### DETAILED DESCRIPTION OF PREFERRED EMBODIMENTS OF THE INVENTION

Definitions

The terms “stencil” or “stencil layer” as used herein refer to a material layer or sheet that is preferably substantially planar, through which one or more variously shaped and oriented channels have been cut or otherwise removed through the entire thickness of the layer, thus permitting substantial fluid movement within the layer (as opposed to simple through-holes for transmitting fluid through one layer to another layer). The outlines of the cut or otherwise removed portions form the lateral boundaries of microstructures that are completed when a stencil is sandwiched between other layers, such as substrates and/or other stencils. Stencil layers can be either substantially rigid or flexible (thus permitting one or more layers to be manipulated so as not to lie in a plane).

Microfluidic Devices Generally

In an especially preferred embodiment, microfluidic devices according to the present invention are constructed using stencil layers or sheets to define channels and/or chambers. As noted previously, a stencil layer is preferably substantially planar and has a channel or chamber cut through the entire thickness of the layer to permit substantial fluid movement within that layer. Various means may be used to define such channels or chambers in stencil layers. For example, a computer-controlled plotter modified to accept a cutting blade may be used to cut various patterns through a material layer. Such a blade may be used either to cut sections to be detached and removed from the stencil layer, or to fashion slits that separate regions in the stencil layer without removing any material. Alternatively, a computer-controlled laser cutter may be used to cut portions through a material layer. While laser cutting may be used to yield precisely dimensioned microstructures, the use of a laser to cut a stencil layer inherently involves the removal of some material. Further examples of methods that may be employed to form stencil layers include conventional stamping or die-cutting technologies, including rotary cutters and other high throughput auto-aligning equipment (sometimes referred to as converters). The above-mentioned methods for cutting through a stencil layer or sheet permits robust devices to be fabricated quickly and inexpensively compared to conventional surface micromachining or material deposition techniques that are conventionally employed to produce microfluidic devices.

After a portion of a stencil layer is cut or removed, the outlines of the cut or otherwise removed portions form the lateral boundaries of microstructures that are completed upon sandwiching a stencil between substrates and/or other stencils. The thickness or height of the microstructures such as channels or chambers can be varied by altering the thickness of the stencil layer, or by using multiple substantially identical stencil layers stacked on top of one another. When assembled in a microfluidic device, the top and bottom surfaces of stencil layers are intended to mate with one or more adjacent layers (such as stencil layers or substrate layers) to form a substantially enclosed device, typically having at least one inlet port and at least one outlet port.

A wide variety of materials may be used to fabricate microfluidic devices having sandwiched stencil layers, including polymeric, metallic, and/or composite materials, to name a few. Various preferred embodiments utilize porous materials including filter materials. Substrates and stencils may be substantially rigid or flexible. Selection of particular materials for a desired application depends on numerous factors including: the types, concentrations, and residence times of substances (e.g., solvents, reactants, and products) present in regions of a device; temperature; pressure; pH; presence or absence of gases; and optical properties. For instance, particularly desirable polymers include polyolefins, more specifically polypropylenes, and vinyl-based polymers.

Various means may be used to seal or bond layers of a device together. For example, adhesives may be used. In one embodiment, one or more layers of a device may be fabricated from single- or double-sided adhesive tape, although other methods of adhering stencil layers may be used. Portions of the tape (of the desired shape and dimensions) can be cut and removed to form channels, chambers, and/or apertures. A tape stencil can then be placed on a supporting substrate with an appropriate cover layer, between layers of tape, or between layers of other materials. In one embodiment, stencil layers can be stacked on each other. In this embodiment, the thickness or height of the channels within a particular stencil layer can be varied by varying the thickness of the stencil layer (e.g., the tape carrier and the adhesive material thereon) or by using multiple substantially identical stencil layers stacked on top of one another. Various types of tape may be used with such an embodiment. Suitable tape carrier materials include but are not limited to polyesters, polycarbonates, polytetrafluoroethlyenes, polypropylenes, and polyimides. Such tapes may have various methods of curing, including curing by pressure, temperature, or chemical or optical interaction. The thickness of these carrier materials and adhesives may be varied.

Device layers may be directly bonded without using adhesives to provide high bond strength (which is especially desirable for high-pressure applications) and eliminate potential compatibility problems between such adhesives and solvents and/or samples. Specific examples of methods for directly bonding layers of non-biaxially-oriented polypropylene to form stencil-based microfluidic structures are disclosed in co-pending U.S. Provisional Patent Application Serial Nos. 60/338,286 (filed Dec. 6, 2001) and 60/393,953 (filed Jul. 2, 2002), which are commonly owned by assignee of the present application and incorporated by reference as if fully set forth herein. In one embodiment, multiple layers of 7.5-mil (188 micron) thickness “Clear Tear Seal” polypropylene (American Profol, Cedar Rapids, Iowa) including at least one stencil layer may be stacked together, placed between glass platens and compressed to apply a pressure of 0.26 psi (1.79 kPa) to the layered stack, and then heated in an industrial oven for a period of approximately five hours at a temperature of 154° C. to yield a permanently bonded microstructure well-suited for use with high-pressure column packing methods. In another embodiment, multiple layers of 7.5-mil (188 micron) thickness “Clear Tear Seal” polypropylene (American Profol, Cedar Rapids, Iowa) including at least one stencil layer may be stacked together. Several microfluidic device assemblies may be stacked together, with a thin foil disposed between each device. The stack may then be placed between insulating platens, heated at 152° C. for about 5 hours, cooled with a forced flow of ambient air for at least about 30 minutes, heated again at 146° C. for about 15 hours, and then cooled in a manner identical to the first cooling step. During each heating step, a pressure of about 0.37 psi (2.55 kPa) is applied to the microfluidic devices.

Notably, stencil-based fabrication methods enable very rapid fabrication of devices, both for prototyping and for high-volume production. Rapid prototyping is invaluable for trying and optimizing new device designs, since designs may be quickly implemented, tested, and (if necessary) modified and further tested to achieve a desired result. The ability to prototype devices quickly with stencil fabrication methods also permits many different variants of a particular design to be tested and evaluated concurrently.

Further embodiments may be fabricated from various materials using well-known techniques such as embossing, stamping, molding, and soft lithography.

In addition to the use of adhesives and the adhesiveless bonding method discussed above, other techniques may be used to attach one or more of the various layers of microfluidic devices useful with the present invention, as would be recognized by one of ordinary skill in attaching materials. For example, attachment techniques including thermal, chemical, or light-activated bonding steps; mechanical attachment (such as using clamps or screws to apply pressure to the layers); and/or other equivalent coupling methods may be used.

Preferred Embodiments

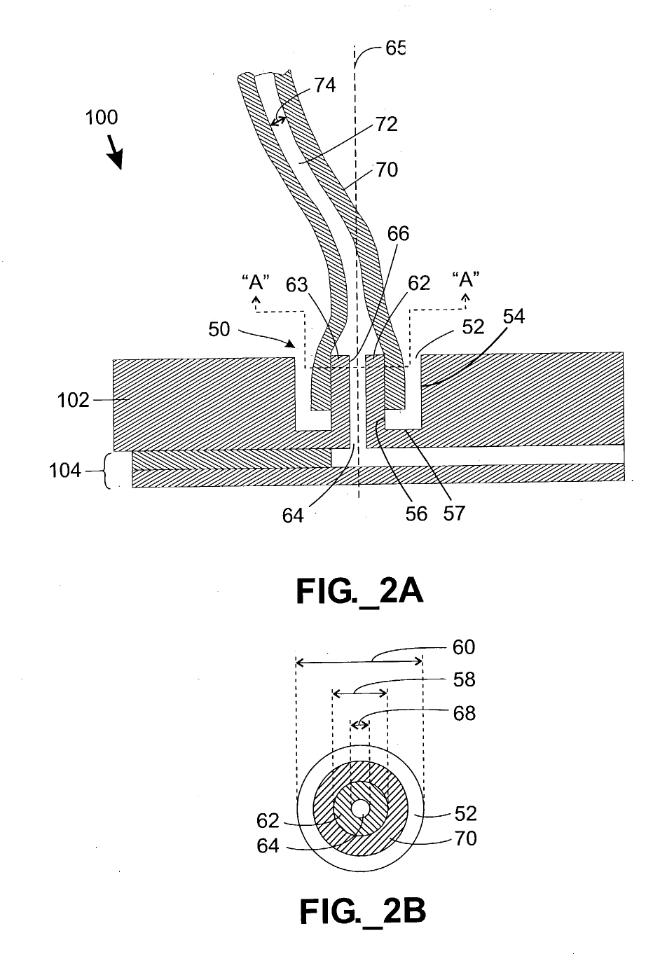

FIGS. 2A and 2B show a connector 50 for a microfluidic device 100 comprising a substrate 102 affixed to a stencil-based microfluidic structure 104. The substrate 102 is substantially planar.

A nipple 62 protrudes from the substrate 102. The nipple 62 is preferably cylindrical where the longitudinal axis 65 of the cylinder is perpendicular to the plane of the substrate 102. The nipple 62 has a nipple diameter 58, a nipple wall 56, and a tip 63.

A well 52 is defined within the substrate 102. The well 52 is preferably annular in shape, where nipple 62 defines the central void of the annulus. A longitudinal axis 65 of the cylinder is substantially perpendicular to the plane of the substrate 102. The well 52 has an outer wall 54, an outer diameter 60, and a floor 57.

A bore 64 penetrates the substrate 102 and is in fluid communication with the microfluidic structure 104. The bore 64 is preferably cylindrical where the longitudinal axis 65 of the cylinder is perpendicular to the plane of the substrate 102. The bore 64 has a diameter 68 and a bore wall 66. The bore 64, the nipple 62 and the well 52 preferably are coaxial.

A fluid conduit 70 may be any flexible and/or elastic conduit suitable for use with the instrument in question and the device 100 as determined by one skilled in the art. The fluid conduit 70 is connected to the device 100 by the inserting the nipple 62 into the conduit bore 72. The nipple diameter 58 is larger than the diameter 74 of the conduit bore 72, thereby causing the conduit 70 to stretch around the nipple 62. Thus, the nipple 62 applies an expanding or stretching force to the conduit 70. This force creates a tight seal between the nipple 62 and the conduit 70. This force also creates friction between the nipple wall 56 and the inner surface of conduit 70, which resists the disconnection of the conduit 70 from the nipple 62.

The strength of the seal between the conduit 70 and the nipple 62 is directly proportional to the magnitude of the expanding force arising from the differential between the conduit bore 72 diameter and the nipple diameter 58 and inversely proportional to the elasticity of the material making up the conduit 70. Accordingly, these factors, i.e., “diameter differential” and conduit elasticity, may be manipulated to achieve a particular desired result.

For example, in very high-pressure applications, it is desirable to achieve a very tight and secure seal. Thus, a conduit with a small bore diameter may be paired with a large nipple diameter to increase the expanding force. Alternatively or in addition, the selected conduit may be composed of a relatively inelastic material such that even a small diameter differential will result in a large expanding force.

In low pressure, high throughput applications, the ease and speed of connecting and disconnecting the microfluidic device from the instrument may be more important than the strength of the seal. In such situations, a more elastic conduit and/or a smaller diameter differential will reduce the expanding force, thus reducing the force required to attach and remove the conduit from the device.

Typically, the well diameter 60 exceeds the combined diameter of the nipple 56 and the conduit 70 to allow the connection of the conduit 70 to the nipple 56 without interference from the outer wall 54. Of course, if the conduit 70 is made of a compressible material, it may be desirable to define a well 52 having a diameter 60 that is less than the combined diameter of the nipple 52 and the conduit 70. In this case, a connection is made by squeezing the conduit 70 into the well 52. This approach may increase seal tightness.

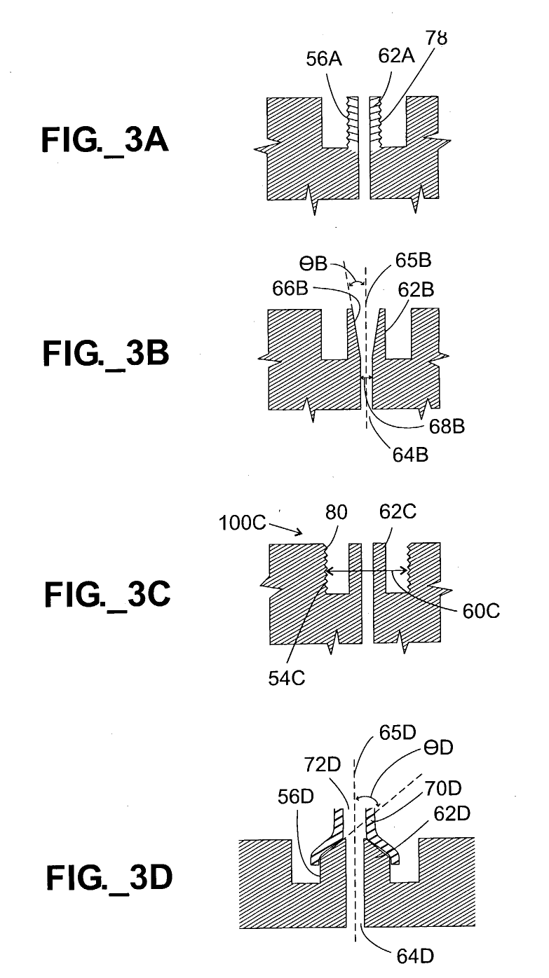

In addition, as illustrated in FIGS. 3A-3D, the physical structure of the nipple 62 may be altered to vary seal tightness as well as other desirable results. For example, referring to FIG. 3A, one or more threads 78 may be defined on the nipple wall 56A. The threads 78 periodically vary the nipple diameter 58A along a portion of the nipple 62A. This variation in diameter 58A periodically increases the expanding force between a conduit (not shown) and the nipple 62A. Thus, seal tightness is increased. However, because the expanding force is increased for only small periodic portions of the interface between the conduit and the nipple 62, the overall force required to attach and remove conduit is reduced. Thus a combination of ease of connection and disconnection and more secure seal is achieved.

Another approach, as shown in FIG. 3C, is to define one or more threads 80 on the outer wall 54C. If, as discussed above, the well diameter 60C is less than the combined diameter of the nipple 62C and the conduit (not shown), then the outer wall of the conduit will contact the outer wall 54C. The threads 80 will act to increase the friction between the outer wall 54C and the conduit, thereby reducing the likelihood of inadvertent disconnection of the conduit from the device 100C.

Referring to FIGS. 3B and 3D, the geometry of the nipple may be altered to achieve various results. For example, as shown in FIG. 3B, the bore wall 66B may be tapered with a taper angle θB. This tapering allows alternative fluid-tight connections to the microfluidic device. For example, the taper angle θB may allow a pipette to be introduced into the bore 64B, such that the bore wall 66B abuts the angled tip of the pipette, forming a seal. Alternatively, a capillary tube may be introduced into the bore 64B. Because the bore diameter 68B decreases along the length of the bore, capillary tubes of varying sizes may be introduced and inserted until the walls of the tube contact the bore wall 66B to form a seal.

As shown in FIG. 3D, the nipple wall 56D may be beveled with a bevel angle θD. The bevel angle θD creates a pointed or partially pointed nipple 62D. This “point” reduces the diameter of the portion of the nipple 62D that is initially introduced into the opening of the conduit 70D. As a result, it is easier to attach the conduit 70D to the nipple 62D. In addition, if the bevel angle θD is selected to form a sharp point at the tip of the nipple 62D, then the transition between the conduit bore 72D and the nipple bore 64D may be smoother than the conduit/nipple transition shown in FIG. 2A. This smooth transition serves to minimize any undesirable turbulence in the fluid flow that might otherwise be induced by the tip of the nipple 62.

Of course, any of these approaches may be combined. For example, the threaded nipple of FIG. 3A may also incorporate the tapered bore of FIG. 3B. Other variations and combinations will be apparent to those skilled in the art.

Connectors in accordance with the present invention may be manufactured by etching with chemicals, plasma, electron beams, lasers or other etching techniques; milling with conventional drills other mechanical milling devices; embossing; injection molding; or any other process which provides the desired structure without contaminating or otherwise damaging the microfluidic structure or instruments in which the microfluidic device is to be used. The appropriate manufacturing method may vary in relation to the anticipated use of the device. For example, etching techniques, which can be expensive and time consuming, may be the only suitable approach for devices to be used in extremely clean environments. It has been found that mechanical milling is the most efficient means, both in terms of cost and manufacturing time, to produce connectors suitable for most current uses of microfluidic devices.

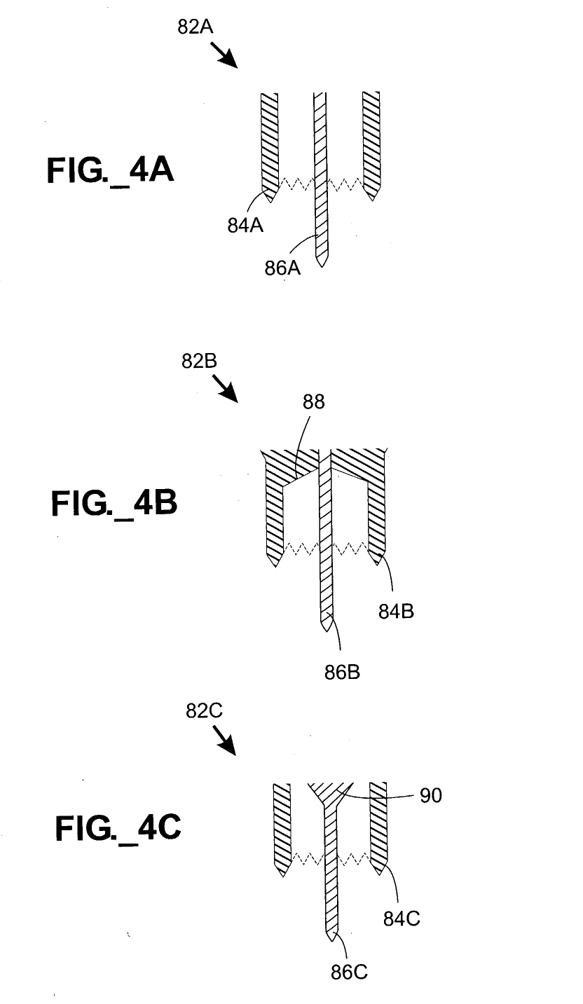

FIGS. 4A-4C illustrate drill bit configurations suitable for milling connectors in accordance with the present invention. For example, FIG. 4A shows a bit 82A made up of an annular bit portion 84A and a central bit portion 86A. The bit 82A may be attached to a drill (not shown) and drilled into the substrate to be used in a microfluidic device. The annular bit portion 84A forms an annular well, thereby simultaneously defining the well and nipple of a connector. The central bit portion 86A forms the bore. These operations may be performed simultaneously, using a combined bit as shown, or sequentially, using separate bits to drill the well and bore independently.

A bit may employ different geometries to create alternative connectors. For example, FIG. 4B shows a bit 82B having an annular bit portion 84B with a beveling bit portion 88. The beveling bit portion 88 will remove material from the nipple wall of the connector being formed, resulting in a configuration such as that illustrated in FIG. 3D. Similarly, as shown in FIG. 4C, the central bit portion 86C may use a tapering bit portion 90 to remove material from the nipple bore, thus creating a connector such as that illustrated in FIG. 3B.

Connectors in accordance with the present invention are preferably formed on a substrate prior to ssembly of the microfluidic device. The process of forming the connector whether etching, milling, embossing or molding—creates an environment that is likely to contaminate the fragile elements of the microfluidic structure. For example, etching techniques may use etchants that introduce contaminants or inadvertently etch into the microfluidic structure. Milling mechanisms could protrude into the structure, physically damaging and leaving burrs that may be difficult to remove from the structure.

Connectors in accordance with the present invention may be assembled from components; however, any joints in the resultant structure may cause weaknesses that make the device unsuitable for high-pressure applications. Thus, it is preferable to form connectors in and integrally with the substrate. Integral connectors do not have joints, thus eliminating the risk of joint failure. Moreover, assembly of connectors would add to the manufacturing process the additional steps of assembly, alignment, and bonding of the components. These additional steps would add complexity and opportunity for defects or flaws into the manufacturing process.

Once connectors in accordance with the present invention are formed in the substrate, the substrate can be affixed to a microfluidic structure using the techniques described above. Because the nipple structure does not extend above the top surface of the substrate, it will not interfere with rollers, platens, or other mechanisms for pressing the substrate and microfluidic structure together during the bonding process.

The particular devices and construction methods illustrated and described herein are provided by way of example only, and are not intended to limit the scope of the invention. The scope of the invention should be restricted only in accordance with the appended claims and their equivalents.

What is claimed is:

1. A microfluidic device having an integral connector permitting attachment of a fluid conduit, the device comprising:
a substantially planar substrate having a top surface and a bottom surface;
a multi-layer stencil-based microfluidic structure affixed to the bottom surface;
a well defined within the substrate, the well having an axis, an outer diameter, an outer wall, a depth, and a floor, wherein the well axis is substantially perpendicular to the plane of the substrate;
a nipple defined within the substrate and positioned on the floor of the well, the nipple having a tip, a nipple diameter, a nipple wall and an axis, wherein the nipple axis is substantially perpendicular to the plane of the substrate; and
a bore defined in the substrate and in fluid communication with the microfluidic structure, the bore having a diameter, an axis, and a bore wall, wherein the bore axis is substantially perpendicular to the plane of the substrate;
wherein the depth of the well is less than the distance between the top surface and the bottom surface, the well outer diameter is greater than the nipple diameter, the nipple diameter is greater than the bore diameter, and the well, the nipple and the bore are aligned coaxially.

2. The microfluidic device of claim 1, further comprising at least one thread defined on the nipple wall.

3. The microfluidic device of claim 1, further comprising at least one thread defined on the outer wall.

4. The microfluidic device of claim 1 wherein the nipple and the substrate are integral.

5. The microfluidic device of claim 1 wherein the bore diameter is tapered.

6. The microfluidic device of claim 1 wherein the nipple is beveled.

7. A method for forming a connector permitting attachment of a fluid conduit to a microfluidic device, the method comprising the steps of:
defining a bore through a substantially planar substrate, the bore having an upper surface and a lower surface, the bore having a diameter and an axis, being substantially perpendicular to the plane of the substrate, and permitting the passage of fluid therethrough; and
defining an annular well in the substrate, the well having a nipple wall, a nipple diameter, an outer wall, an outer diameter, and an axis, the well being substantially perpendicular to the plane of the substrate and positioned coaxially with the bore;
wherein the depth of the well is less than the distance between the upper surface and the lower surface of the substrate, the interior diameter is greater than the bore diameter, and the well is externally accessible along the periphery of the microfluidic device.

8. The method of claim 7, wherein the steps of defining a bore and defining an annular well are performed simultaneously.

9. The method of claim 7, wherein the steps of defining a bore and defining an annular well are performed sequentially.

10. The method of claim 8, wherein the simultaneous defining of the bore and the annular ring are performed using a drill bit comprising an annular bit portion and a central bit portion.

11. The method of claim 7, wherein the step of defining an annular well includes defining at least one thread on the nipple wall.

12. The method of claim 7, wherein the step of defining an annular well includes defining at least one thread on the outer wall.

13. The method of claim 7, wherein the step of defining a bore includes tapering the bore.

14. The method of claim 7, wherein the step of defining an annular well includes beveling the nipple wall.

15. A method for fabricating a microfluidic device comprising the steps of:
providing a substrate having a top surface;
defining a bore through the substrate, the bore having a central axis;
defining in the substrate at least one annular well, the well having an axis coaxial with the bore, to form a nipple with a top surface that does not protrude above the top surface of the substrate;
providing a stencil layer defining at least one microfluidic structure;
registering the stencil layer and the substrate such that the bore is in fluid communication with the at least one microfluidic structure; and
affixing the channel-containing layer to the substrate;
wherein the step of drilling the bore is performed prior to the registering and affixing steps.

16. The method of claim 15, wherein the step of defining an annular well includes defining at least one thread on the nipple wall.

17. The method of claim 15, wherein the step of defining an annular well includes defining at least one thread on the outer wall.

18. The method of claim 15, wherein the step of defining a bore includes tapering the bore.

19. The method of claim 15, wherein the step of defining an annular well includes beveling the nipple.
